(19) United States
(12) Patent Application Publication
(10) Pub. No.: US 2025/0267581 A1
(43) Pub. Date: Aug. 21, 2025

(54) METHOD AND DEVICE FOR REDUCING POWER CONSUMPTION OF TERMINAL HAVING WAKEUP RECEIVER IN WIRELESS COMMUNICATION SYSTEM

(71) Applicant: Samsung Electronics Co., Ltd., Suwon-si, Gyeonggi-do (KR)

(72) Inventors: Jaewon LEE, Suwon-si (KR); Seunghoon CHOI, Suwon-si (KR); Hyunseok RYU, Suwon-si (KR); Hyewon YANG, Suwon-si (KR); Junyung YI, Suwon-si (KR)

(21) Appl. No.: 18/858,094

(22) PCT Filed: Jun. 23, 2023
(86) PCT No.: PCT/KR2023/008756

§ 371 Date: Oct. 18, 2024

(30) Foreign Application Priority Data
Jun. 28, 2022 (KR) 10-2022-0079033

(51) Int. Cl. H04W 52/02; H04W 74/0833; H04W 76/27

(52) U.S. Cl. CPC H04W 52/0235; H04W 74/0833; H04W 76/27

(57) ABSTRACT

The present disclosure relates to a 5G or 6G communication system for supporting a higher data transfer rate. In addition, the present disclosure provides a method for reducing power consumption of a terminal having a wakeup receiver in a mobile communication system.

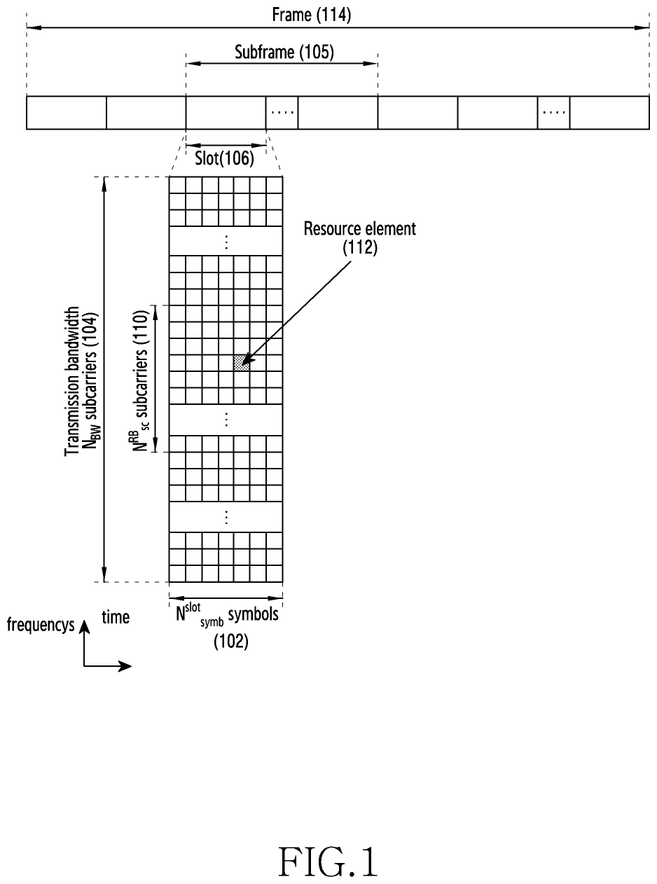

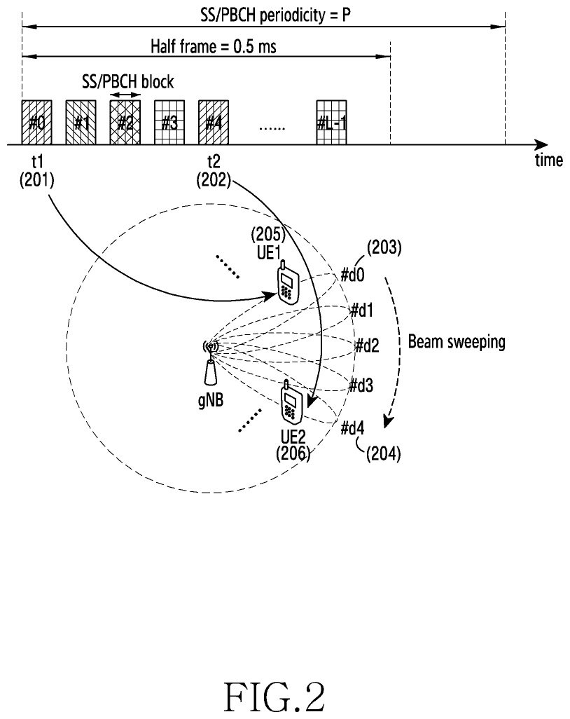

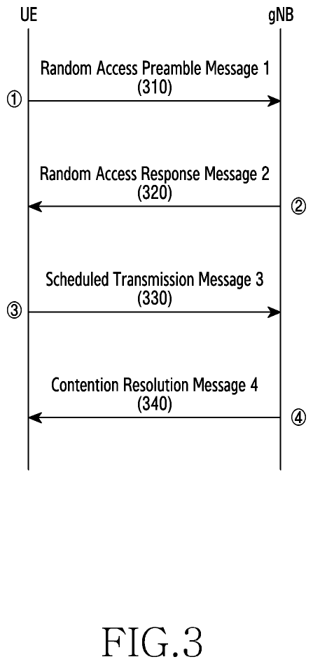

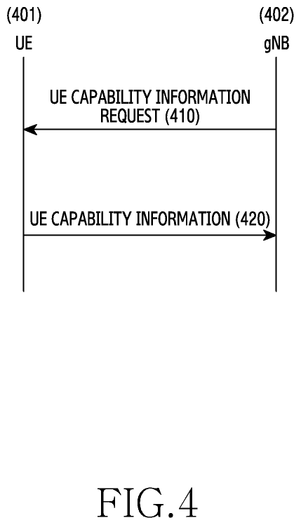

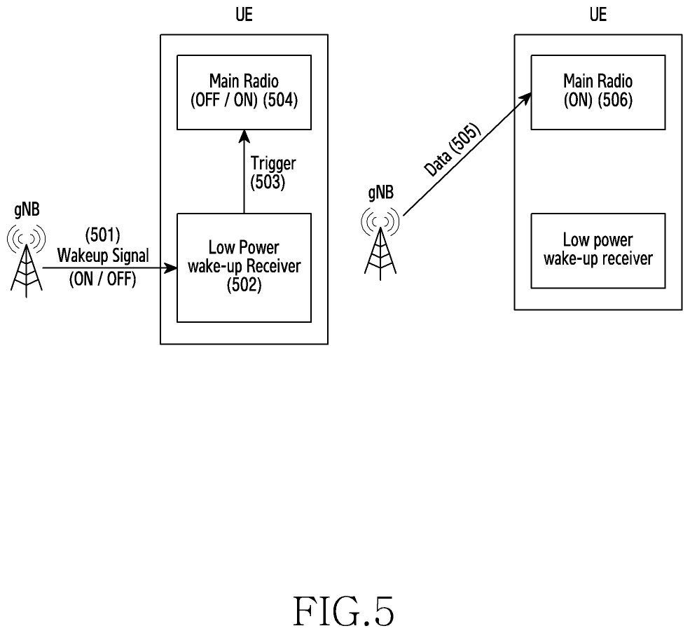

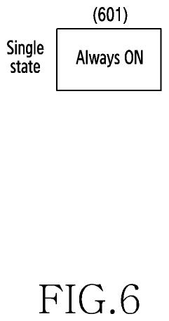

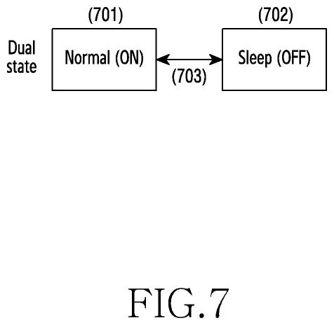

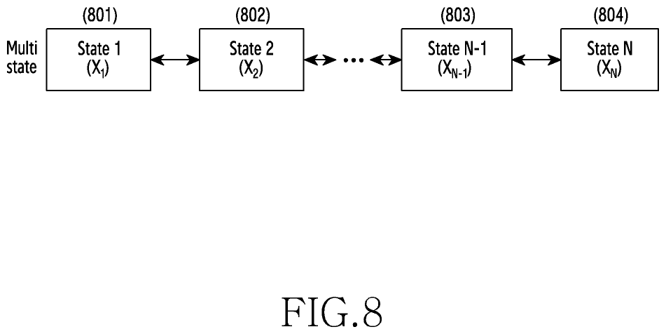

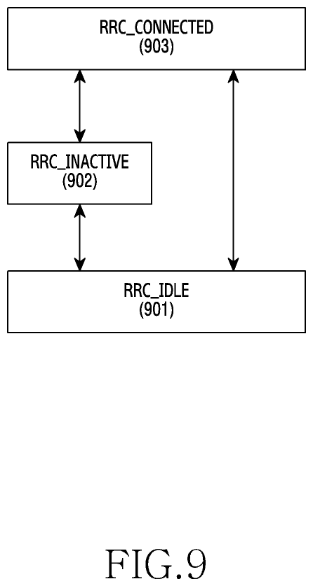

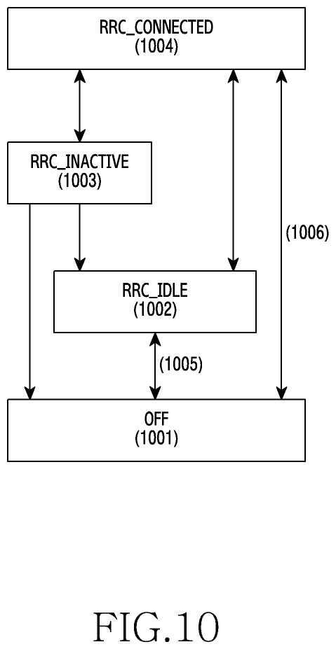

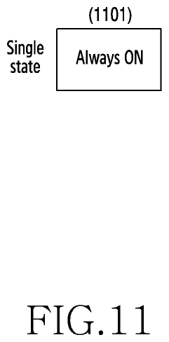

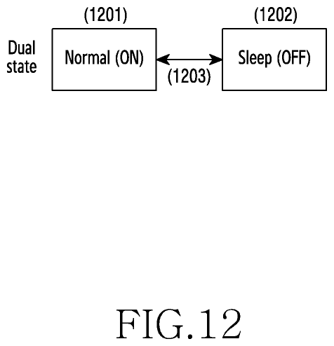

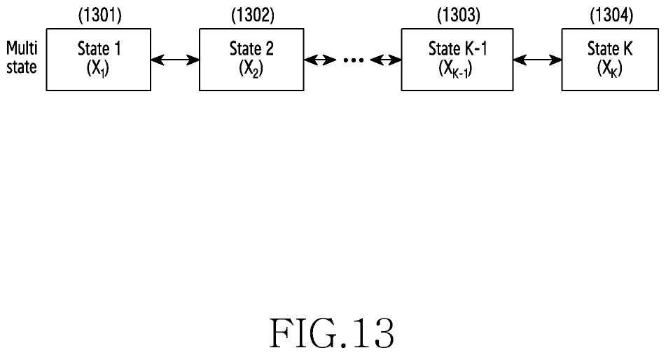

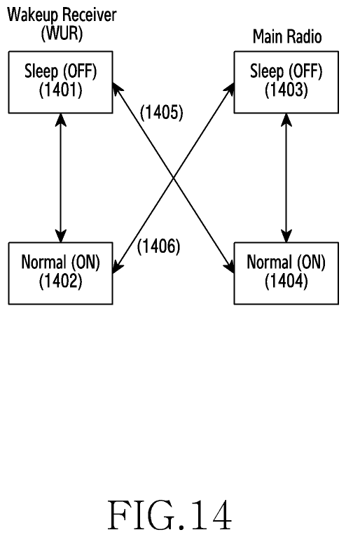

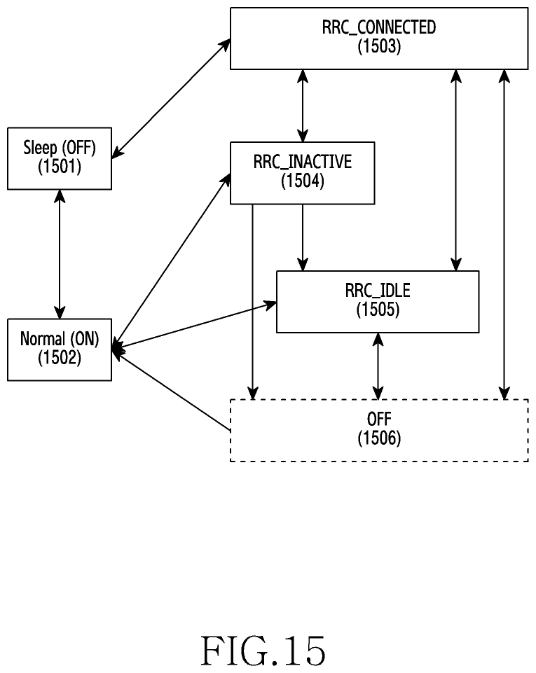

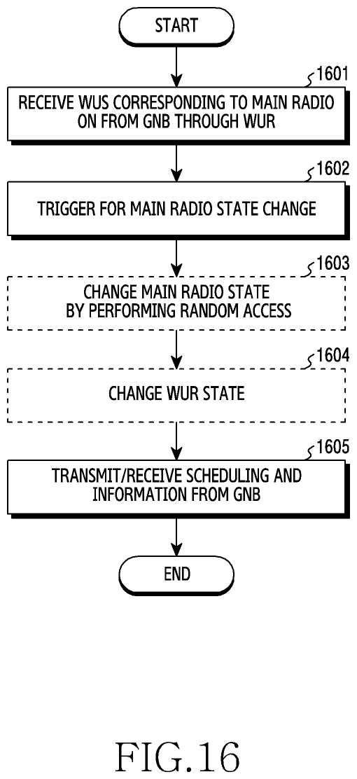

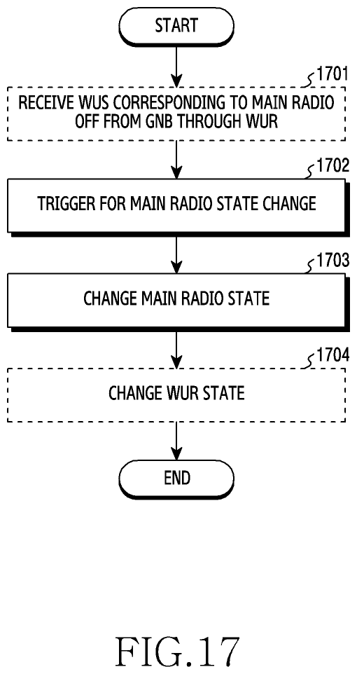

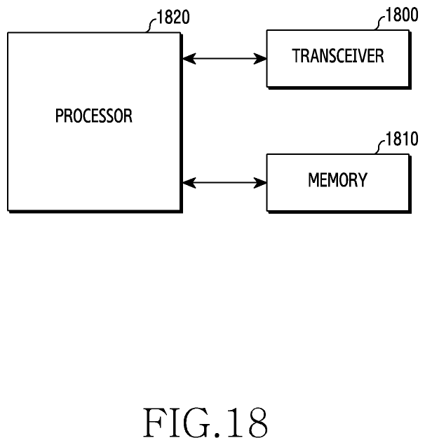

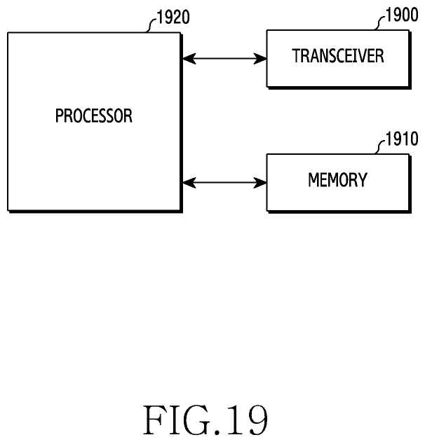

### TECHNICAL FIELD

The disclosure relates to a wireless communication system and, more particularly, to a method and a device for reducing power consumed by a UE having a wakeup receiver.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to reduce power consumption of terminals.

1. A method performed by a terminal of a wireless communication system, the method comprising:
receiving a wakeup-related signal from a base station through a wakeup receiver configured to receive only the wakeup-related signal;
determining a state of a main radio configured to transmit/receive data, based on the wakeup-related signal; and
determining a state of the wakeup receiver, based on the state of the main radio,
wherein the wakeup receiver and the main radio are independently configured.

2. The method of claim 1, wherein, the determining of a state of a main radio configured to transmit/receive data, based on the wakeup-related signal, in case that the wakeup-related signal is a signal indicating main radio ON, controlling the state of the main radio to be ON, or changing the state of the terminal to an RRC connected state.

3. The method of claim 2, wherein, the changing of the state of the terminal to an RRC connected state, controlling to perform a random access immediately after receiving the wakeup-related signal through the main radio, or after a predetermined time.

4. The method of claim 1, wherein, in the determining of a state of a main radio configured to transmit/receive data, based on the wakeup-related signal, in case that the wakeup-related signal is a signal indicating main radio OFF, controlling the state of the main radio to be OFF, or changing the state of the terminal to an RRC inactive state or RRC idle state.

5. The method of claim 1,
wherein, in case that the determined state of the main radio is OFF, the state of the terminal is an RRC inactive state or RRC idle state, and
in case that the determined state of the main radio is ON, the state of the terminal is an RRC connected state.

6. The method of claim 1,
wherein, in the determining of a state of the wakeup receiver, based on the state of the main radio, in case that the determined state of the main radio is OFF, controlling the state of the wakeup receiver to be ON, and
in case that the determined state of the main radio is ON, controlling the state of the wakeup receiver to be OFF.

7. The method of claim 1, further comprising controlling the state of the main radio to be OFF after transmission/reception of the data is completed.

8. The method of claim 1, further comprising receiving configuration information regarding operations of the wakeup receiver from the base station,
wherein the configuration information comprises at least one of information regarding a state change period of the wakeup receiver, information regarding state mapping between the wakeup receiver and the main radio, and information regarding a wakeup-related signal providing period of the base station.

9. A terminal of a wireless communication system, the terminal comprising:
a wakeup receiver;
a main radio; and
at least one processor,
wherein the at least one processor is configured to:
receive a wakeup-related signal from a base station through a wakeup receiver configured to receive only the wakeup-related signal,
determine a state of a main radio configured to transmit/receive data, based on the wakeup-related signal, and
determine a state of the wakeup receiver, based on the state of the main radio, and
wherein the wakeup receiver and the main radio are independently configured.

10. The terminal of claim 9, wherein the at least one processor is configured to, in case that the wakeup-related signal is a signal indicating main radio ON, control the state of the main radio to be ON, or change the state of the terminal to an RRC connected state.

11. The terminal of claim 10, wherein the at least one processor is configured to, in case that the wakeup-related signal is a signal indicating main radio ON, control the state of the main radio to be ON, or change the state of the terminal to an RRC connected state.

12. The terminal of claim 9, wherein the at least one processor is configured to, in case that the wakeup-related signal is a signal indicating main radio OFF, control the state of the main radio to be OFF, or change the state of the terminal to an RRC inactive state or RRC idle state.

13. The terminal of claim 9,
wherein, in case that the determined state of the main radio is OFF, the state of the terminal is an RRC inactive state or RRC idle state, and
in case that the determined state of the main radio is ON, the state of the terminal is an RRC connected state.

14. The terminal of claim 9,
wherein the at least one processor is configured to, in case that the determined state of the main radio is OFF, control the state of the wakeup receiver to be ON, and
in case that the determined state of the main radio is ON, control the state of the wakeup receiver to be OFF.

15. The terminal of claim 9,
wherein the at least one processor is configured to receive configuration information regarding operations of the wakeup receiver from the base station, and
the configuration information comprises at least one of information regarding a state change period of the wakeup receiver, information regarding state mapping between the wakeup receiver and the main radio, and information regarding a wakeup-related signal providing period of the base station.
